(19) United States
(12) Patent Application Publication
(10) Pub. No.: US 2014/0348605 A1
(43) Pub. Date: Nov. 27, 2014

(54) DRILLING TOOL FOR COMPOSITE MATERIAL

(71) Applicant: TAEGUTEC, LTD., Dalseong-gun, Daegu (KR)

(72) Inventor: Jung Hoon Park, Daegu (KR)

(73) Assignee: TAEGUTEC, ltd., Dalseong-gun (KR)

(21) Appl. No.: 14/345,207

(22) PCT Filed: Sep. 18, 2012
(86) PCT No.: PCT/KR2012/007447

§ 371 Date: Mar. 14, 2014

(30) Foreign Application Priority Data
Sep. 23, 2011 (KR) 10-2011-0096413

(51) Int. Cl. B23B 51/02; B23B 51/00

(52) U.S. Cl. CPC B23B 51/02; B23B 51/009; B23B 2251/14; B23B 2251/408; B23B 2226/27
USPC 408/224

(57) ABSTRACT

A cutting tool is suitable for cutting a composite material. A drilling tool according to one embodiment includes a drill body and a shank. The drill body includes ribs formed in a spiral shape along the axis direction of the drill body, chip discharging grooves formed between the ribs, and a drill head formed at one end of the drill body where the shank is not formed. The drill head is formed in a multi-stage and first and second cutting edges are formed interposing a step portion therebetween, and the second cutting edge is formed toward the drill head. A point angle of the first cutting edge is 90° to 130°, a dish angle of the second cutting edge is 5° to 15°, and a twist angle between the chip discharging groove and the rotational axis of the drill body is 20° to 40°.

### TECHNICAL FIELD

The present invention relates to a drilling tool. More particularly, the present invention relates to a drilling tool for solving a problem that occurs at an inlet and an exit of a hole during hole machining of a composite material.

### BACKGROUND ART

A composite material made of resin and fiber has properties of light weight, high strength and high durability. Due to such properties, the composite material is used in various industries relating to vehicles, airplanes, ships, etc. Accordingly, a tool for machining the composite material has been developed.

In the meantime, when the composite material formed by laminating resin and fiber is machined by using a drilling tool, delamination (splitting of laminated layers at the inlet and the exit of the hole of the work-piece), splintering (remaining of fragments or broken pieces) and fraying (wearing of resin in the work-piece) may occur. Additional machining processes are required to eliminate delamination, splintering and fraying. Further, these additional processes complicate the manufacturing process and increase costs.

Accordingly, there is a need to improve the shape of a drilling tool for suppressing the occurrence of delamination, splintering and fraying in hole machining of composite material.

### DISCLOSURE OF INVENTION

The present invention has been made in an effort to provide a drilling tool for a composite material that can suppress occurrence of problems such as delamination, splintering and fraying at the inlet and the outlet of the hole during hole machining of the composite material.

A drilling tool for a composite material according to one exemplary embodiment of the present invention comprises a drill body and a shank formed at one end of the drill body. The drill body comprises ribs formed in a spiral shape along the axis direction of the drill body, chip discharging grooves formed between the ribs, and a drill head formed at the other end of the drill body where the shank is not formed. The drill head is formed in a multi-stage, a first cutting edge and a second cutting edge is formed interposing a step portion therebetween, and the second cutting edge is formed toward the drill head. A point angle of the first cutting edge is 90° to 130°, a dish angle of the second cutting edge is 5° to 15°, and a twist angle formed between the chip discharging groove and the rotational axis of the drill body is 20° to 40°.

An inclination angle in a radial direction of the first cutting edge may be 5° to 35°.

The length of the step portion may be 3% to 50% of the length of the diameter of the drill body.

A drilling tool for a composite material according to another exemplary embodiment of the present invention comprises a drill body and a shank formed at one end of the drill body. The drill body comprises ribs formed in a spiral shape along the axis direction of the drill body, chip discharging grooves formed between the ribs, and a drill head formed at the other end of the drill body where the shank is not formed. The drill head is formed in a multi-stage, a first cutting edge and a second cutting edge is formed interposing a step portion therebetween, and the second cutting edge is formed toward the shank. A point angle of the first cutting edge is 90° to 130°, a leading angle of the second cutting edge is 20° to 50°, and a twist angle formed between the chip discharging groove and the rotational axis of the drill body is 20° to 40°.

An inclination angle in a radial direction of the first cutting edge may be 5° to 35°.

The length of the step portion may be 3% to 50% of the length of the diameter of the drill body.

According to one exemplary embodiment of the present invention, time and cost incurred in the process can be saved by solving the problems of delamination, splintering and fraying at the inlet and the outlet of the hole during the hole machining of the composite material. Especially, the process can be optimized by applying a suitable drilling tool according to composite material, which comprises lots of fiber or lots of resin.

### BRIEF DESCRIPTION OF DRAWINGS

FIG. 1 is a perspective view of a drilling tool according to a first exemplary embodiment of the present invention.

FIG. 2a is an enlarged view of a drilling tool according to a first exemplary embodiment of the present invention, while FIG. 2b is a sectional view cut along line II-II of FIG. 2a.

FIG. 3 shows a state of hole machining of a work-piece by using a drilling tool according to a first exemplary embodiment of the present invention.

FIG. 4a is an enlarged view of a drilling tool according to a second exemplary embodiment of the present invention, while FIG. 4b is a sectional view cut along line IV-IV of FIG. 4a.

FIGS. 5a and 5b are photographs showing the inlet and the exit of the hole of the work-piece which is machined by using a drilling tool according to a first exemplary embodiment of the present invention, respectively.

FIGS. 6a and 6b are photographs showing the inlet and the exit of the hole of the work-piece which is machined by using a drilling tool according to a comparative embodiment, respectively.

FIGS. 7a and 7b are photographs showing the inlet and the exit of the hole of the work-piece which is machined by using a drilling tool according to a second exemplary embodiment of the present invention, respectively.

FIGS. 8a and 8b are photographs showing the inlet and the exit of the hole of the work-piece which is machined by using a drilling tool according to a comparative embodiment, respectively.

### BEST MODE FOR CARRYING OUT THE INVENTION

Hereinafter, exemplary embodiments of the present invention, for a person of ordinary skill in the art to easily practice, will be described thoroughly with reference to the accompanying drawings.

Parts which are irrelevant to the explanation are omitted to explain the present invention clearly, and like reference numerals designate like elements throughout the specification. Further, the sizes of elements are arbitrarily represented for the convenience of explanation, and thus the present invention is not limited as illustrated.

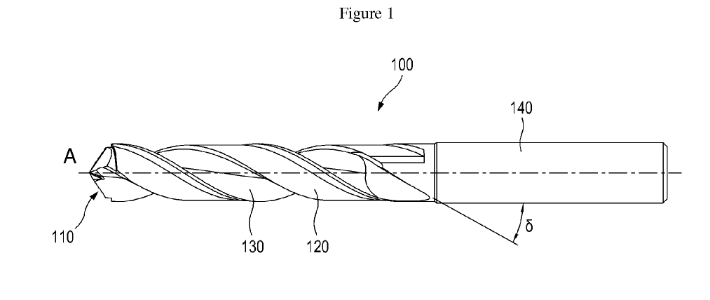

FIG. 1 is a perspective view of a drilling tool according to a first exemplary embodiment of the present invention. Referring to FIG. 1, a drilling tool 100 according to the first embodiment comprises a drill body and a shank 140. The drill body comprises a drill head 110 at one end thereof, which is used directly in hole machining. Further, the drill body comprises ribs 120 and a chip discharging groove 130 between the ribs 120, which forms a discharging path of chips generated during hole machining. The shank 140 is formed at another end of the drill body where the drill head 110 is not formed, such that it can rotate the drill body.

As shown in FIG. 1, the ribs 120 and the chip discharging groove 130 are formed in a spiral shape along the rotational axis of the drilling tool 100. Since a twist angle β between the rotational axis and extension lines of the ribs 120 and the chip discharging groove 130 is formed to be inclined towards the axis direction in the drilling tool, cutting torque decreases as the twist angle gets bigger, and a favorable effect on chip discharge is expected by the lift effect that lifts up chips. However, in a drilling tool for a composite material, delamination (i.e., a splitting of layers) may occur, in particular, at an inlet of the hole.

Thus, in the first embodiment, in order to minimize delamination by the lift effect at the inlet of the hole and maintain proper cutting torque, the twist angle β is formed in about 20° to about 40°.

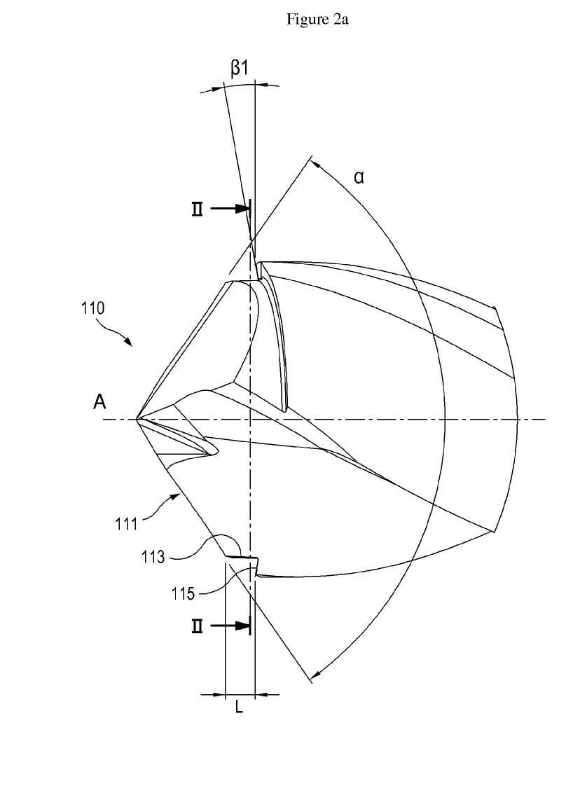

FIG. 2a is an enlarged view of the drill head of the drilling tool according to the first exemplary embodiment of the present invention, while FIG. 2b is a sectional view cut along line II-II of FIG. 2a. The drill head 110 according to the first embodiment will be described in detail with reference to the drawings.

The drill head 110 is formed in a multi-stage in the first embodiment. Specifically, a first cutting edge 111 and a second cutting edge 115 are formed interposing a step portion 113 therebetween, and the length L of the step portion 113 is formed in about 3% to about 50% of the diameter of the cutting tool 100. The first cutting edge 111 and the second cutting edge 115 may be formed along the same chip discharging groove 130.

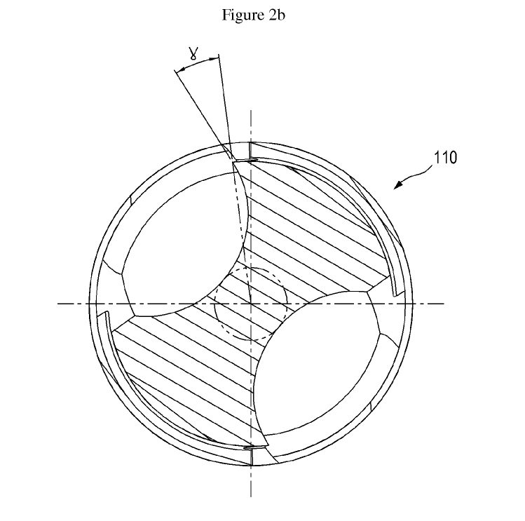

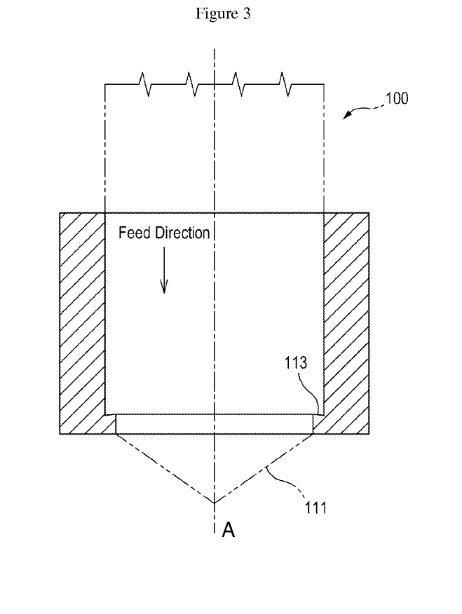

FIG. 3 shows a state of hole machining of a work-piece by using a drilling tool according to the first exemplary embodiment of the present invention. Referring to FIG. 3, the first cutting edge 111 and the second cutting edge 115 are fed with the same speed such that the cutting by penetration of the first cutting edge 111 is followed by cutting with the second cutting edge 115, and thus the first cutting edge 111 does not affect the work-piece being cut by the second cutting edge 115. As such, during hole machining by using the drilling tool 100 according to the first embodiment, the work-piece is primarily cut by the first cutting edge 111, and then the peripheral portion of the primarily cut portion is secondarily cut from the outermost region by the second cutting edge 115 which enters with an interval from the first cutting edge. Thus, problems by splintering during hole machining of the composite material can be solved.

Meanwhile, a non-penetrated hole which has one closed end other than a penetrated hole may be required when using the composite material. Accordingly, a distance between the first cutting edge 111 and the second cutting edge 115, i.e., a length of a step portion 113 may be formed in about 5% to about 20% of the diameter of drilling tool 100, thereby suppressing delamination at the inlet and the exit of the penetrated hole when forming the penetrated hole by using the drilling tool, as well as using the drilling tool in forming the non-penetrated hole. For example, the length of step portion 113 may be formed in between about 0.5 mm to about 1.3 mm. As such, since the step portion is formed to be limited in length, the drilling tool has an effect of multi-stage cutting as described above, and it is possible to machine both the penetrated hole and the non-penetrated hole by minimizing the difference between the machining depth by the first cutting edge and the machining depth by the second cutting edge.

Further, cutting performance is improved since the first cutting edge 111 is formed sharply by not forming a margin portion at the outer peripheral thereof.

Referring to FIG. 2a, a point angle α is formed in between about 90° to about 130° in the first embodiment. Accordingly, problems occurred during machining the composite material can be solved by reducing machining resistance when machining by the first cutting edge 111, and together by transferring a direction of force acted on the cutting edge from the axial direction to the radial direction.

In the first embodiment, the second cutting edge 115 is formed in a direction toward the drill head 110, and a dish angle β1 of the second cutting edge 115 is formed in between 5° to 15°. If the dish angle β1 of the second cutting edge 115 is smaller than 5°, cutting with the second cutting edge is insufficient thereby the exit of the hole being deteriorated, and if the dish angle β1 is greater than 15°, the second cutting edge experiences early abrasion due to the small tool angle. Thus, in the first embodiment, by forming the dish angle β1 between 5° to 15°, sufficient cutting from the outermost portion of the hole by the second cutting edge is achieved, and the early abrasion of the second cutting edge is prevented, such that the favorable quality of the inlet and the exit of the hole can be maintained. Especially, when the dish angle β1 is formed in between 8° to 12° holes with better quality may be expected.

In case of a composite material, in particular material abundant with fiber, splintering and fraying may easily occur at the exit of the hole, however such problem can be solved by the shapes of the first cutting edge 111 and the second cutting edge 115, wherein the second cutting edge 115 cuts the remaining portion of the work-piece after the penetration of the first cutting edge 111. As such, the drilling tool 100 of the first embodiment can be used properly for the hole machining of the composite material, in particular material abundant with fiber.

Meanwhile, by forming the point angle in certain range to solve the problems occurred when hole machining of the composite material, force acted in the radial direction during drilling process is increased. Referring to FIG. 2b, in the first embodiment, an inclination angle γ in the radial direction of the first cutting edge 111 is formed between 5° to 35°. Forming the cutting edge with such inclination angle reduces the machining resistance in the radial direction during machining thereby improving the quality of hole of the composite material.

FIG. 4a is an enlarged view of a drilling tool according to a second exemplary embodiment of the present invention, while FIG. 4b is a sectional view cut along line IV-IV of FIG. 4a. In describing a second exemplary embodiment of the present invention referring to FIGS. 4a and 4b, the features equivalent to those in the first embodiment will be abbreviated or omitted for the purpose of convenience. Thus, omission of equivalent features does not necessarily mean such features are excluded from the second embodiment.

According to the second embodiment, a drill head 210 is formed in a multi-stage such that a first cutting edge 211 and a second cutting edge 215 are formed interposing a step portion 213 therebetween, the length L of the step portion 213 is formed in between about 3% to about 50% of the diameter of the drilling tool. Similar to the first embodiment, the first cutting edge 211 and the second cutting edge 215 are fed with the same speed such that cutting with the first cutting edge 211 is followed by cutting with the second cutting edge 215, and thus the first cutting edge 211 does not affect the work-piece being cut with the second cutting edge 215. As such, during hole machining according to the second embodiment, the work-piece is primarily cut by the first cutting edge 211, and then the peripheral portion of the primarily cut portion is secondarily cut from the outermost region by the second cutting edge 115 which enters with an interval from the first cutting edge, thereby solving the problems due to delamination during hole machining of the composite material.

Meanwhile, if the length L of step portion 213 is formed in between about 5% to about 20% of the diameter of the drilling tool, both machining a penetrated hole and a non-penetrated hole are possible as necessary by minimizing the difference between the machining depth by the first cutting edge 211 and the machining depth by the second cutting edge 215. Further, according to the second embodiment, the first cutting edge 211 is formed sharply by not forming a margin portion at the outer peripheral portion thereof, thereby improving the cutting performance.

Referring to FIG. 4a, a point angle α is formed in between about 90° to about 130° in the second embodiment, such that problems occurred during machining the composite material can be solved by reducing machining resistance when machining, and together by transferring a direction of force acted on the cutting edge from the axial direction to the radial direction.

In the second embodiment, contrary to the first embodiment, the second cutting edge 215 is formed in a direction towards the shank. In this regard, a leading angle β2 is formed in between 20° to 50°. If the leading angle β2 is formed smaller than 20°, the cutting resistance is increased, and if a leading angle β2 is greater than 50°, cut in the radial direction is insufficient thereby deteriorating the exit of the hole. Thus, by forming the leading angle β2 in between 20° to 50°, favorable qualities of the inlet and the exit of the hole may be maintained by transferring a direction of cutting force from the axial direction to the radial direction when cutting the remaining portion of the work-piece after the penetration of the first cutting edge 211. Especially when forming the leading angle β2 in between 30° to 40°, an improved quality of hole machining may be expected.

In case of a composite material, in particular material abundant with resin, delamination at the inlet of the hole may easily occur by the lift effect of the work-piece, and the delamination at the exit of the hole may also easily occur due to the force in the feed direction of the drilling tool on the bottom surface of the work-piece. However, according to the second embodiment, since the second cutting edge 215 cuts the remaining portion of the work-piece after the penetration of the first cutting edge 211, and the second cutting edge 215 is formed in a certain leading angle and transfers a direction of the cutting force from the axial direction to the radial direction, the above problems can be solved. As such, the drilling tool according to the second embodiment may be used properly for the hole machining of the composite material, in particular material abundant with resin.

As described previously, by forming the point angle with a certain range to solve problems occurred when hole machining of the composite material, force acted in the radial direction during drilling machining is increased. Referring to FIG. 4b, in the second embodiment, an inclination angle γ in the radial direction of the first cutting edge 211 is formed in between 5° to 35°. Forming the cutting edge with such inclination angle reduces the machining resistance in the radial direction during machining thereby improving the quality of hole.

Meanwhile, in the second embodiment, ribs and chip discharging grooves are formed in a spiral shape along the rotational axis of the drilling tool creating the twist angle δ in between about 20° to about 40°, thereby minimizing delamination by the lift effect at the inlet of the hole, and maintaining proper cutting torque.

Hereafter, the drilling tool according to the embodiments of the present invention will be described in comparison with drilling tool according to a comparative embodiment through hole machining tests on the composite material. The specifications of the first and second embodiments used in the exemplary test are as described above, and a drill head of a drilling tool according to the comparative embodiment is not formed in a multi-stage and has a point angle of 140°.

In the exemplary test, drilling tools according to the first embodiment and the comparative embodiment are used in hole machining for glass fiber reinforced polymer (GFRP), and drilling tools according to the second embodiment and the comparative embodiment are used in hole machining for carbon fiber reinforced polymer (CFRP), respectively, and the results are compared. The machining depth of the work-piece is 20 mm, and the feed speed per minute V and the feed speed per rotation fr are set at 100 m/min and 0.07 mm/rev, respectively.

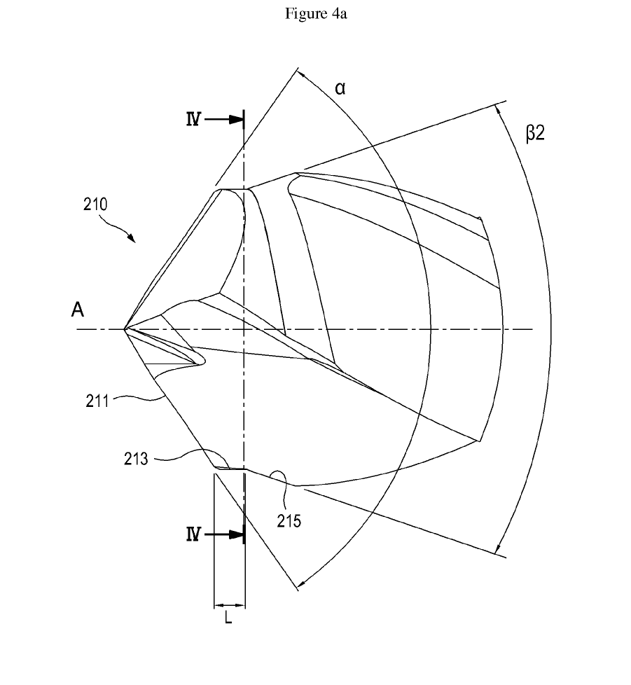

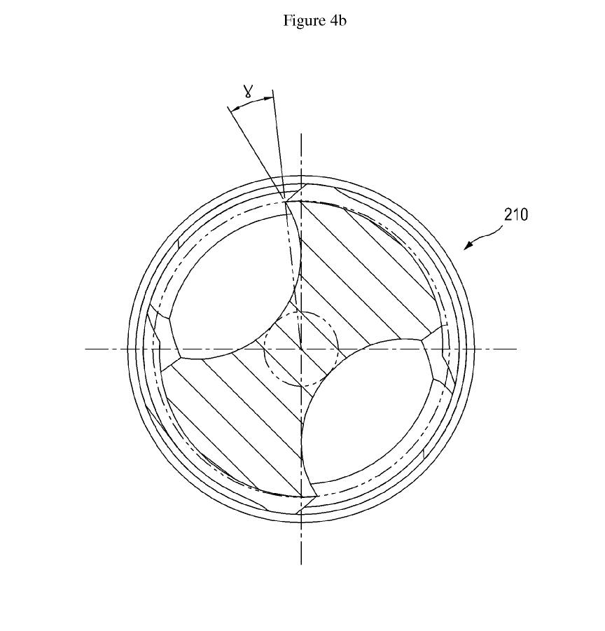

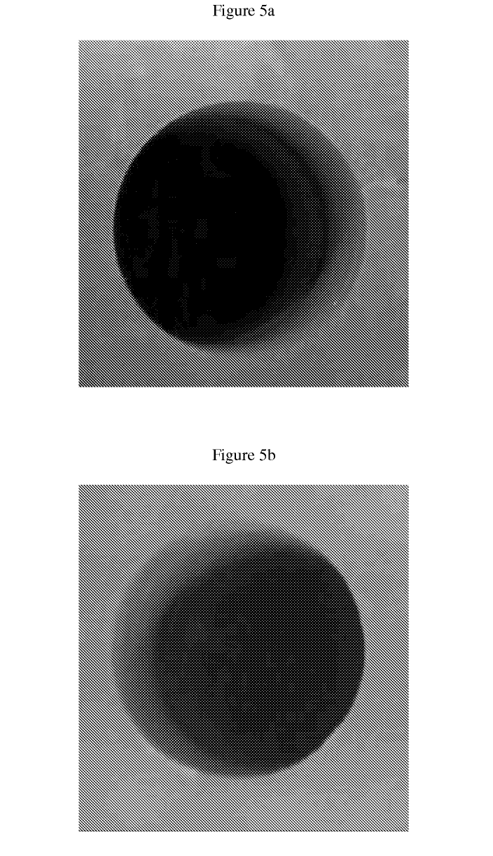

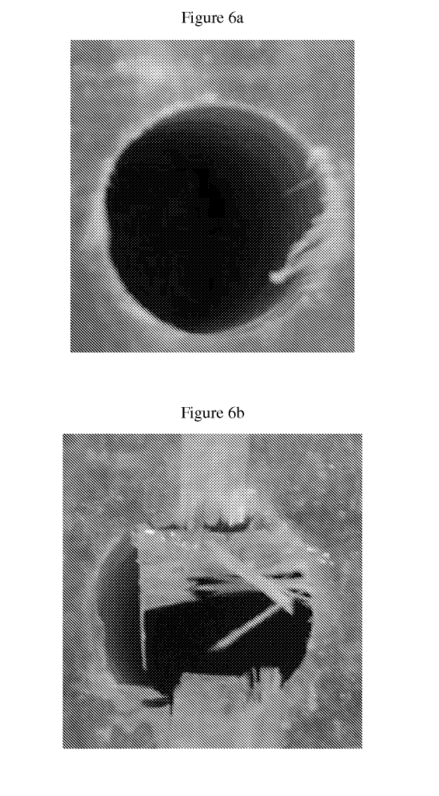

FIGS. 5a and 5b are photographs showing the inlet and the exit of the hole of the work-piece (glass fiber reinforced polymer) which is machined by using the drilling tool according to the first exemplary embodiment of the present invention, respectively, while FIGS. 6a and 6b are photographs showing the inlet and the exit of the hole of the work-piece (glass fiber reinforced polymer) which is machined by using the drilling tool according to the comparative embodiment, respectively.

Referring to FIGS. 5a to 6b, it can be verified that delamination occurs at the inlet of the hole and splintering and fraying occur at the exit of the hole when the drilling tool according to the comparative embodiment is used in machining glass fiber reinforced polymer. However, the inlet and the exit of the hole can be machined cleanly without such defects when using the drilling tool according to the first embodiment.

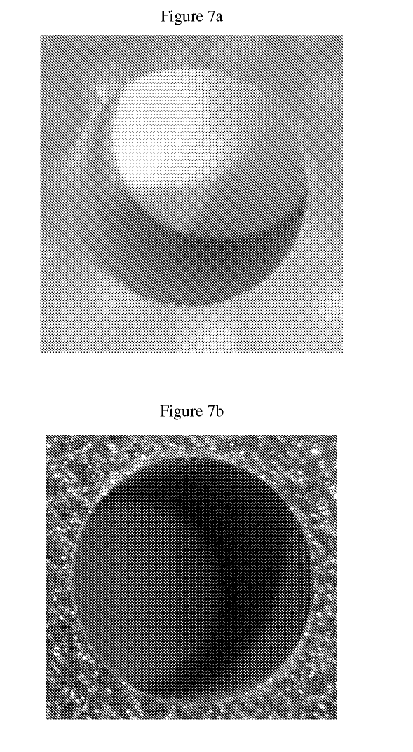

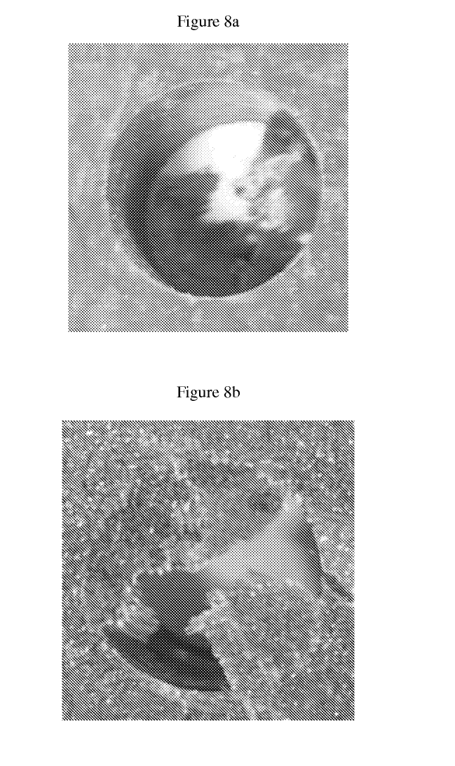

FIGS. 7a and 7b are photographs showing the inlet and the exit of the hole of the work-piece (carbon fiber reinforced polymer) which is machined by using the drilling tool according to the second exemplary embodiment of the present invention, respectively, while FIGS. 8a and 8b are photographs showing the inlet and the exit of the hole of the work-piece (carbon fiber reinforced polymer) which is machined by using the drilling tool according to the comparative embodiment, respectively. It can be verified with reference to the drawings that delamination occurs at the exit of the hole when a drilling tool according to the comparative embodiment is used in machining carbon fiber reinforced polymer. However, the inlet as well as the exit of the hole can be machined cleanly when using a drilling tool according to the second embodiment.

During the above exemplary tests, only the formation of multi-stage structure and point angle conditions were changed and compared to describe the effect. However, effects according to other conditions of the drill head are as described above. That is, in the drilling tool according to the aforementioned embodiments, the first cutting edges 111 and 211 and the second cutting edges 115 and 215 in the drill heads 110 and 210 have a divisional role, and the point angle α, the dish angle β1, or the leading angle β2 of the second cutting edges 115 and 215, the radial inclination angle γ, the twist angle δ and so on are optimized, thereby reducing machining resistance and improving the quality of hole machining on the composite material. Further, by optimizing the length of step portions 113 and 213, both penetrated hole and non-penetrated hole can be selectively machined with single drilling tool.

While the present invention has been described with preferred embodiments, it is not limited to the disclosed embodiments, but, on the contrary, the scope of the present invention is determined by the following claims. That is, it is to be understood for a person ordinary skilled in the art that the present invention is intended to cover various modifications and equivalent arrangements included within the scope of the appended claims.

1. A drilling tool for a composite material comprising a drill axis (A), a drill body and a shank formed at one end of the drill body,
wherein the drill body comprises ribs formed in a spiral shape along the axis direction of the drill body, chip discharging grooves formed between the ribs, and a drill head formed at the other end of the drill body where the shank is not formed;
wherein the drill head is formed in a multi-stage and a first cutting edge and a second cutting edge is formed interposing a step portion therebetween, the second cutting edge being formed toward the drill head; and wherein:
a point angle of the first cutting edge is 90° to 130°,
a dish angle of the second cutting edge is 5° to 15°, and
a twist angle formed between the chip discharging groove and the rotational axis of the drill body is 20° to 40°.

2. The drilling tool for the composite material according to claim 1, wherein an inclination angle in a radial direction of the first cutting edge is 5° to 35°.

3. The drilling tool for the composite material according to claim 1, wherein the length of the step portion is 3% to 50% of the length of the diameter of the drill body.

4. A drilling tool for a composite material comprising a drill axis (A), a drill body and a shank,
wherein the drill body comprises ribs formed in a spiral shape along the axis direction of the drill body, chip discharging grooves formed between the ribs, and a drill head formed at the other end of the drill body where the shank is not formed;
wherein the drill head is formed in a step shape and a first cutting edge and a second cutting edge is formed interposing a step portion therebetween, the second cutting edge being formed toward the shank portion; and wherein:
a point angle of the first cutting edge is 90° to 130°,
a leading angle of the second cutting edge is 20° to 50°, and
a twist angle formed between the chip discharging groove and the rotational axis of the drill body is 20° to 40°.

5. The drilling tool for the composite material according to claim 4, wherein an inclination angle in a radial direction of the first cutting edge is 5° to 35°.

6. The drilling tool for the composite material according to claim 4, wherein the length of the step portion is 3% to 50% of the length of the diameter of the drill body.

7. A drilling tool for a composite material comprising a drill axis (A), a drill body and a shank formed at one end of the drill body,
wherein the drill body comprises ribs formed in a spiral shape along the axis direction of the drill body, chip discharging grooves formed between the ribs, and a drill head formed at the other end of the drill body where the shank is not formed;
wherein the drill head is formed in a multi-stage and a first cutting edge and a second cutting edge is formed interposing a step portion therebetween, the second cutting edge being sloped relative to drill axis (A); and wherein:
a point angle of the first cutting edge is 90° to 130°,
a twist angle formed between the chip discharging groove and the rotational axis of the drill body is 20° to 40°; and
the second cutting edge is either:
(a) radially outwardly sloped towards the one end of the drill body with a leading angle (β2) of 20° to 50°, or
(b) radially outwardly sloped towards the other end of the drill body with a dish angle (β1) of 5° to 15°.

8. The drilling tool for the composite material according to claim 7, wherein the second cutting edge is radially outwardly sloped towards the one end of the drill body with a leading angle (β2) of 20° to 50°.

9. The drilling tool for the composite material according to claim 8, wherein the second cutting edge is radially outwardly sloped towards the one end of the drill body with a leading angle (β2) of 30° to 40°.

10. The drilling tool for the composite material according to claim 9, wherein:
an inclination angle in a radial direction of the first cutting edge is 5° to 35°;
the length of the step portion is 3% to 50% of the length of the diameter of the drill body; and
the length of the step portion is between 0.5 mm to 1.3 mm.

11. The drilling tool for the composite material according to claim 7, wherein the second cutting edge is radially outwardly sloped towards the other end of the drill body with a dish angle (β1) of 5° to 15°.

12. The drilling tool for the composite material according to claim 11, wherein the second cutting edge is radially outwardly sloped towards the other end of the drill body with a dish angle (β1) of 8° to 12°.

13. The drilling tool for the composite material according to claim 12, wherein:
an inclination angle in a radial direction of the first cutting edge is 5° to 35°;
the length of the step portion is 3% to 50% of the length of the diameter of the drill body; and
the length of the step portion is between 0.5 mm to 1.3 mm.

14. The drilling tool for the composite material according to claim 7, wherein an inclination angle in a radial direction of the first cutting edge is 5° to 35°.

15. The drilling tool for the composite material according to claim 7, wherein the length of the step portion is 3% to 50% of the length of the diameter of the drill body.

16. The drilling tool for the composite material according to claim 15, wherein the length of the step portion is between 0.5 mm to 1.3 mm.
